(19) United States
(12) Patent Application Publication
(10) Pub. No.: US 2012/0118426 A1
(43) Pub. Date: May 17, 2012

(54) COILED TUBING WITH IMPROVED FATIGUE RESISTANCE AND METHOD OF MANUFACTURE

(75) Inventors: DAVID L. DANIEL, HOUSTON, TX (US); WILLIAM D. VAN ARNAM, III, HUFFMAN, TX (US); DANNY J DENNIS, HUFFMAN, TX (US); KEVIN J. ELLIOTT, HOUSTON, TX (US); CLAYTON D. HARGIS, HOUSTON, TX (US)

(73) Assignee: QUALITY TUBING, INC., HOUSTON, TX (US)

(21) Appl. No.: 13/271,972

(22) Filed: Oct. 12, 2011

Related U.S. Application Data
(60) Provisional application No. 61/392,146, filed on Oct. 12, 2010.

(51) Int. Cl. F16L 9/00; B23K 31/02

(52) U.S. Cl. 138/177; 228/144

(57) ABSTRACT

New methods of manufacturing coiled tubing result in increased useful life of the coiled tubing string by creating an enhanced strip-to-strip weld zone having load bearing and/or fatigue resistance properties substantially equal to or greater than the load bearing and/or fatigue resistance properties of the strip base material. The enhanced weld zone is transition into the nominal tubing to reduce stress concentration.

### CROSS REFERENCE TO RELATED APPLICATIONS

This application claims priority to and benefit of U.S. Provisional Application Ser. No. 61/392,146, filed on Oct. 12, 2010, the entire disclosure of which is incorporated herein by reference for all purposes.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and claimed herein relate to the manufacture of enhanced fatigue resistance coiled tubing from lengths of flat strip material.

2. Description of the Related Art

Coiled tubing refers to a continuous length of tubing formed from flat strip that has been welded end-to-end. Coiled tubing is produced in various lengths up to and exceeding 30,000 feet and, because of its length, is stored by spooling the tubing onto a reel. Coiled tubing is widely used in the oil and gas industry for drilling, completion, production, and workover operations. In addition, coiled tubing may be used for control lines, umbilical lines, and other applications requiring relatively long continuous lengths of durable tubing.

In oil field use, coiled tubing is repeatedly unspooled from the reel and re-spooled onto the reel. In addition, the tubing is subjected to varying internal pressurizations, including super- and sub-atmospheric pressurizations, bending loads, axial loads and torsional loads. It will be appreciated that because of the length of the coiled tubing being used in any given operation, multiple different stress and strain states can exist on different sections of the tubing at any given time. Because of the stresses and strains imposed upon the coiled tubing during use, a reel of coiled tubing (or a section of coiled tubing) typically is limited to a specified life, usually defined by a number of cycles, such as unspool/respool cycles, to avoid or at least minimize catastrophic failure caused by fatigue. Coiled tubing life has been predicted based on theoretical and empirical data and, perhaps not surprisingly, a whole industry has developed around coiled tubing life predictions. Despite these predictive efforts, fatigue failures sometimes occur; and unless special care and management of the strip-to-strip weld has been implemented, fatigue crack initiation is most often located in a strip-to-strip weld or adjacent a strip-to-strip weld.

Indeed, it is well documented that the strip-to-strip weld in coiled tubing does not perform as well in fatigue as the parent or base material. In addition, as the mechanical strength of coiled tubing strip material has increased, the differences in performance of the strip-to-strip weld compared to the parent material have increased.

Art related to the inventions disclosed herein include U.S. Published Pat. Appl. No. 20060157539, which discloses “[c]ontinuous coil tubing made from shorter lengths of flat metal strip which are spliced end-to-end and formed into tubular form and seam welded and thereafter introduced into a forging or hot reduction process. Finished coil tubing is withdrawn from the process at a different rate than flat metal strip is fed into the process. Welds made to the flat metal strip blend into and substantially disappear from the finished coil tubing.” The substance and disclosure of U.S. Patent Application Serial No. 20060157339 is incorporated herein by reference for all purposes.

U.S. Pat. No. 5,456,405 discloses “[a] dual bias weld is an improved weld for joining strips to be formed into coiled tubing. Tubing is formed from a first strip and a second strip, the first and second strips being of the same width. A planar end surface is formed on an end of the first strip, the plane of the planar end surface being defined by a line lying along a top surface of the first strip at an acute angle with respect to the longitudinal direction of the first strip and a line lying along an edge surface of the first strip at an acute angle with respect to the longitudinal direction of the first strip. Similarly, a planar end surface is formed on an end of the second strip, the plane of the planar end surface being defined by a line lying along a top surface of the second strip at an acute angle with respect to the longitudinal direction of the second strip and a line lying along an edge surface of the second strip at an acute angle with respect to the longitudinal direction of the second strip. A composite strip is formed by welding the planar end surface of the first strip to the planar end surface of the second strip to form a dual bias weld. Excess weldment is then removed from top, bottom and edge surfaces of the composite strip such that the width of the weld is identical to the width of the first and second strips. Coiled metal tubing is then formed from the composite strip.” The substance and disclosure of U.S. Pat. No. 5,456,405 is incorporated herein by reference for all purposes.

U.S. Pat. Nos. 4,863,091 and 5,191,911 disclose “[a] system for making a long length of seam-welded tubing from shorter lengths of flat metal strip which are spliced end-to-end and formed into tubular form and seam-welded. Adjoining ends of two successive lengths of the strip are trimmed at supplementary angles, one of which is an acute angle. The trimmed ends are abutted and welded, preferably with weldment extending beyond each such end. All surfaces of the weld are finished to match the dimensions of the strip. The tubing, along with the welded joints, is heat treated as the tubing is formed to produce a product substantially free of internal surface roughness along the splice welds.” The substance and disclosure of U.S. Pat. Nos. 4,863,091 and 5,191,911 are incorporated herein by reference for all purposes.

U.S. Pat. No. 4,629,218 discloses, “[a] coil tubing string for injecting fluids into a well includes one or more tapered wall tubing sections welded in series with adjacent straight wall tubing sections to form smooth joints there between. The tubing string has tubing sections of dissimilar wall thicknesses. Such tapered wall tubing sections are used to connect tubing sections of dissimilar wall thicknesses wherein the transitions from one tubing section to another is smooth and continuous as one progresses from a thin wall tubing section to a heavy wall tubing section in an ascending order.” The substance and disclosure of U.S. Pat. No. 4,629,218 is incorporated herein by reference for all purposes.

The inventions disclosed and taught herein are directed to manufacturing methods for coiled tubing that result in improved life ratings by, among other things, increasing the tubing resistance to fatigue failure, especially in and adjacent to the strip weld areas.

### BRIEF SUMMARY OF THE INVENTION

In brief summary of some aspects of our inventions, a method of manufacturing a length of coiled tubing is claimed comprising providing a first length of strip material having a nominal thickness and a first end; providing a second length of strip material having a nominal thickness substantially the same as the nominal thickness of the first length of strip material, and having a second end; providing an area of increased material thickness extending longitudinally away from each strip end for a predetermined distance; forming a weld along the first and second ends, thereby joining the first and second strips together to create a new length of strip material; and forming the new length of strip material into tubing.

Similarly, in brief summary of some of the aspects of our inventions, coiled tubing may be formed from a plurality of lengths of flat strip material welded together, in which the tubing has a nominal wall thickness along its length; and the tubing has an enhanced strip weld area having a wall thickness that is at least 103% of the nominal tubing wall thickness and a longitudinal length away from the weld of at least twice the enhanced wall thickness; and first and second transitions between the enhanced weld area and the unenhanced coiled tubing. Further, the flat strip weld may be biased with respect to a longitudinal strip axis at an angle in the range of 45° to 75°, and the first and second transitions may comprise a shallow angle of about 3.5°.

### BRIEF DESCRIPTION OF THE SEVERAL VIEWS OF THE DRAWINGS

FIG. 1 illustrates the creation of a conventional bias strip weld.

FIGS. 2A-2C illustrate several possible embodiments of symmetrical and asymmetrical enhanced strip ends.

FIGS. 3, 4 and 5 illustrate alternative embodiments of creating enhanced weld areas for the strip-to-strip welds.

FIGS. 6 and 7 illustrate two of several possible transitions between the enhanced weld area and the nominal strip material.

FIGS. 8A and 8B illustrate a strip-to-strip weld in an enhanced weld area with transitions normal to the strip length axis.

FIGS. 9A-9C illustrate a strip-to-strip weld in an enhanced weld area with transitions parallel to the bias weld axis.

FIGS. 10A-10G illustrate several possible transition area entry and exit portions.

FIG. 11 illustrates a length of enhanced coiled tubing being spooled onto a reel.

FIGS. 12 and 13 illustrate two of many embodiments of creating an enhanced weld area after the strip material has been formed into coiled tubing.

### DETAILED DESCRIPTION OF THE INVENTION

The Figures described above and the written description of specific structures and functions below are not presented to limit the scope of what we have invented or the scope of the appended claims. Rather, the Figures and written description are provided to teach any person skilled in the art to make and use the inventions for which patent protection is sought.

Those skilled in the art will appreciate that not all features of a commercial embodiment of the inventions are described or shown for the sake of clarity and understanding. Persons of skill in this art will also appreciate that the development of an actual commercial embodiment incorporating one or more aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While development of a commercial embodiment might be complex and time-consuming in an absolute sense, such efforts would be, nevertheless, a routine undertaking for those of skill in this art having benefit of this disclosure. It is understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the disclosed invention or the appended claims.

Those of skill in the art will appreciate that the various individual aspects of the invention disclosed herein may be combined in whole or in part in any number of combinations, whether or not explicitly discussed below.

We have discovered and created new methods of manufacturing coiled tubing from multiple lengths of flat strip material that result in increased useful life of the resulting coiled tubing string. In general, our manufacturing processes create an enhanced strip-to-strip weld area having load bearing and/or fatigue resistance properties substantially equal to or greater than the load bearing and/or fatigue resistance properties of the strip base material. One aspect of our invention involves increasing the amount of load bearing material in and/or adjacent the weld zone to offset detrimental effects of the strip welding process. For example, and without limitation, if the strip-to-strip weld causes a 5% decrease in a physical property of the base material and/or coiled tubing, such as yield strength, ultimate strength or fatigue resistance, sufficient additional material, which may include strip, weldment, or other foreign material, is added to the weld area so that the load that can be borne by the weld-affected material is substantially equal to or greater than the load that can be borne by the base material and/or coiled tubing that has been unaffected by the strip-to-strip welding process.

The invention contemplates that the strip-to-strip weld can be a conventional coiled tubing strip weld, such as but not limited to, the bias weld disclosed in U.S. Pat. Nos. 4,863,091 and 5,191,911. FIG. 1 illustrates this type of conventional coiled tubing strip weld 100 that is biased 45° to the longitudinal strip axis, A. First strip material 102 is sheared or otherwise cut on the preferred bias angle, e.g., 45°, and second strip material 104 is sheared on the supplementary angle, e.g. 135°. Welding process 106 may begin in first weld tab 108, extend across the strip material bias and end on second weld tab 110. It will be appreciated that weld tabs 108 and 110 are removed after welding and one or more surfaces of the weld area may be dressed, such as by grinding, planishing, shot peening or other process. It also will be appreciated that strip-to-strip butt welds may be suitable for use instead of or in conjunction with strip-to-strip bias welds because of the use of an enhanced weld area for the butt weld. It also will be appreciated that strip welding techniques other than those disclosed in U.S. Pat. Nos. 4,863,091 and 5,191,911 can be used to create an enhanced strip-to-strip weld, such as a solid-state joining process, including but not limited to friction stir welding.

It is contemplated that strip material can be fabricated at the strip mill with increased thicknesses at each end to provide the additional load bearing area in what will become the enhanced weld area. We also contemplate that load bearing material and/or additional load bearing material can be provided to create the enhanced weld area by a build-up process, such as welding or other conventional material deposition techniques. We also contemplate that the enhanced weld area can be produced by the tubing manufacturer, such as by a mechanical upsetting process, including cold forging or hot forging. Also, strip material of a given thickness can be drawn to a reduced wall thickness, except adjacent the ends of the strip to thereby create an area that will become the enhanced weld area. Alternately, we contemplate that a separate plate or plates of material can overlay the joint between the first and second strips to form the enhanced weld area.

Our invention contemplates that the enhanced weld area can be disposed 1) symmetrical about the wall thickness centerline of the strip; 2) asymmetrical about the wall thickness centerline, with differing amounts of extra material on what will become the inside and outside surfaces of the tubing; 3) asymmetrical about the wall thickness centerline with material added to the outside surface only; or 4) asymmetrical about the wall thickness centerline with material added to the inside surface only.

Our invention contemplates that the enhanced weld area is smoothly transitioned into the base or parent strip material to minimize any stress concentration caused by a change in thickness. The transition area can be parallel to the strip transverse axis or biased to the transverse axis. For example, the transition area can be biased relative to the strip similarly or dissimilarly to the bias of the strip weld. Alternately, the transition area can follow a defined pattern, such as a sinusoidal curve.

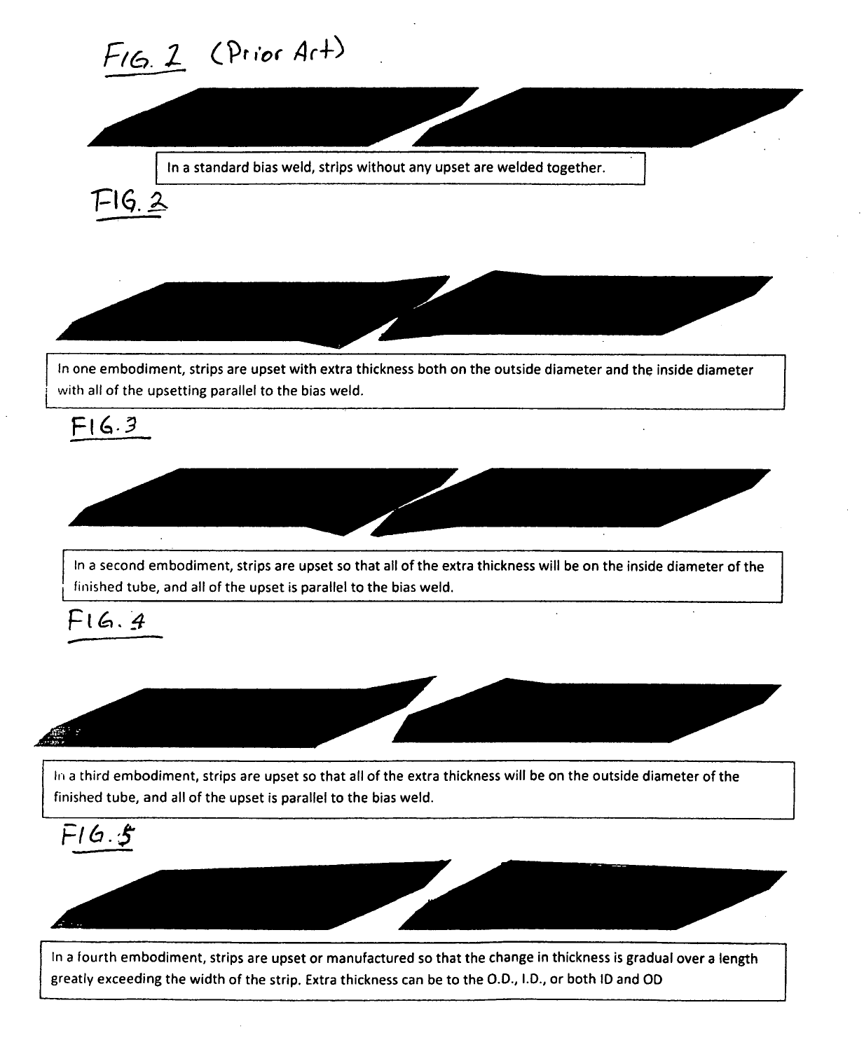

Turning now to more specific disclosures of certain of the many possible embodiments of our inventions, FIGS. 2A, 2B and 2C illustrate coiled tubing strip material 200 having an area of increased thickness 202 adjacent and including the strip ends 204. FIG. 2A shows an enhanced strip end area 202 having an increased wall thickness distributed symmetrically about the strip centerline, C. FIGS. 2B and 2C show the enhanced strip end area having an increased wall thickness distributed asymmetrically about the strip centerline, C. In FIG. 2B, the increased wall thickness is associated with what will become the inside surface of the coiled tubing, and in FIG. 2C the increased wall thickness is associated with what will become the outside surface of the coiled tubing. It will also be appreciated that increased thickness in the enhanced area can be associated with both sides of the centerline, C, but in differing or asymmetrical amounts.

The amount of increase in wall thickness in the enhanced area is preferably dependent on the quality and properties of the strip weld, including the heat-affected zone, that joins the two enhanced strip ends together. The purpose of the enhanced area is to increase the load bearing capabilities of the weld zone to at least the load bearing capabilities of the parent or un-enhanced strip material. We have discovered that for coiled tubing of conventional wall thicknesses and diameters, an enhanced area having a wall thickness of about 110% of the wall thickness, t, of the parent or base strip material is effective to achieve the stated purposes of the invention. Of course, there are numerous reasons why a person of skill, having benefit of this teaching, would choose more or less material increase in the enhanced area depending on the particular strip material, welding process and/or stress environment. It is contemplated that the increase in wall thickness for the enhanced weld area may range between about 103% and about 125%, and preferably from about 108% to about 112% of the nominal strip thickness. We have found that an increase of 110% of the nominal strip material wall thickness, t, is effective for current high strength coiled tubing strip material.

The enhanced weld area adjacent each strip end may be created by the strip mill, such as by cold or hot forging or upsetting, cold or hot stretching, computer-controlled rolling processes or pre- or post-heat treatment manufacturing processes. The goal of such manufacturing processes is to create a length of strip material having strip ends with a predetermined increased wall thickness, which material has the same or substantially the same physical properties as the nominal thickness base material. However, the invention also contemplates that the increased thickness strip ends may have physical properties greater than or less than the nominal thickness parent material.

Alternately, if strip material of substantially consistent wall thickness is received at the tubing mill, the tubing mill may create strip ends of increased wall thickness (and therefore load bearing area), such as those described above, by processes such as cold or hot forging, cold or hot stretching or drawing. The enhanced weld area can be created on the strip ends prior to joining the strip ends by welding, or the enhanced weld area can be created, such as by a process described above, after the strip ends have been welded together.

Additionally, as shown in FIG. 3, the increased area strip end 304 may be formed by material deposition techniques, including, but not limited to welding, thermal spray, ion beam, cladding, laser cladding, plasma spray, vapor deposition, flame spraying, or electric arc spraying and the like, as illustrated as 306.

Still further, as illustrated in FIG. 4, the strip ends 404, 405 may be enhanced by overlaying the strips with a plate 408 of appropriate thickness and bonding the plate 408 to the weld zone 410. For example, in one embodiment comprising strips 404 and 405 of substantially constant nominal thickness, t, after the strip-to-strip weld 401 has been created, one side of the strip weld zone 410 is overlaid with a plate 408 having substantially the same width as the parent strip 404 and 405, and a predetermined thickness. The plate 406 is bonded 410 to the joined strip by cladding techniques, welding techniques, amorphous diffusion bonding techniques and/or cold or hot forging techniques. The resulting wall thickness of the enhanced weld area, tₑ, will be between about 103% and about 125%, and preferably about 110% of the nominal strip wall thickness, t. Depending on the strip weld 401 process used, it may be desirable to dress the strip weld, such as by grinding before overlaying plate 406. The substance and disclosure of U.S. Pat. No. 6,419,147 is incorporated herein by reference for all purposes. Alternately, the material deposition techniques discussed above may be used to create the additional thickness 408.

Further still, as illustrated in FIG. 5, the strip ends may be enhanced by overlaying each strip end 504 and 505 with plates 508a and 508b of predetermined thickness. Plates 508a and 508b are bonded to the parent strip material by suitable techniques, such as those disclosed above. Thereafter, the enhanced strips ends 512 are welded together, 501, by techniques such as those discussed above.

While the embodiments discussed above have illustrated joining strip material of similar thicknesses, t, it will be appreciated that the present invention my benefit the joining of strip material having different thicknesses, t₁ and t₂ (not shown). I such circumstances, it is contemplated that the material added to create the enhanced weld area would be adjusted to create an enhanced weld area having a substantially constant wall thickness, tₑ, as described above.

Those of skill will now appreciate that, to the extent the strip welding process degrades or diminishes one or more of the physical properties or performance characteristics of the strip base material, by increasing the amount of load-bearing material in this area, such as by increasing the wall thickness, the tubing manufacturing process is able to create a weld area that can withstand at least the axial, bending, and/or fatigue strains that can be borne by the base strip material. Such improved coiled tubing may have a life rating based on the properties or performance of the base material and not on the diminished properties or performance of the weld zone.

It is preferred that the enhanced weld area have a transition portion at each end that transitions the increased thickness, tₑ, back to the nominal strip thickness, t, to thereby eliminate or at least minimize any stress concentration effect created by the change in thickness. As illustrated in FIG. 6, a preferred form of transition 614 comprises blending the enhanced weld area 612 into the base strip 600 at a shallow angle of up to about 7°. Through mathematical modeling of the complex stresses and strains imposed on coiled tubing during use, we have discovered that a transition angle of about 3.5° or less is beneficial for the subject invention. It will be appreciated that other forms of transitions known to reduce the stress concentration effect may be used. For example, FIG. 7 illustrates a transition 714 having a double radius, r₁ and r₂.

The transition portion may be formed in the enhanced weld area before or after the strip weld is made, and may be integral with the formation of the increased thickness of the enhanced weld area. For example, for the strip material illustrated in FIGS. 3-6, a transition portion comprising a shallow angle of about 3.5° may be machined into the strip material, such as by milling or grinding. Those of skill will appreciate the benefit of minimizing and orienting any resulting tool marks parallel to the length of the strip material.

FIGS. 8A and 8B illustrate a first strip 804 that has an enhanced weld area 812. The enhanced weld area 812 may be created by any of the processes discussed above. The enhanced weld area 812 has a shallow angle transition portion 814, such as the preferred 3.5° transition discussed above. Similarly, a second strip 805 has an enhanced weld area 813, which also may be created by any of the processes discussed above. The enhanced weld area 813 has a shallow angle transition portion 815, such as the preferred 3.5° transition discussed above. The enhanced strip ends 812 and 813 are prepared and welded together as has been discussed above and in the U.S. patents incorporated herein. Thereafter, the weld 810 may be dressed, if desired, such as by grinding, on preferably all sides so that the weld area has substantially the same dimensions as the adjacent enhanced strip material.

It will be appreciated from FIGS. 8A and 8B, that the enhanced weld area is asymmetrical about the strip centerline, C. In the example illustrated, the asymmetrical side will become, preferably, the inside surface of the coiled tubing. It will be appreciated that the asymmetrical surface could also be used to form the outside surface of the resulting coiled tubing. Although FIGS. 8A and 8B show the weld 810 extending through the entire enhanced weld area thickness, it will be appreciated that the weld may extend only through the parent material thickness and be overlaid by a plate or deposited material, as discussed above.

Also illustrated in FIGS. 8A and 8B is the relationship between the weld 810 and the transitions 814 and 815. In this example, the weld is biased relative to the strip length axis at an angle, α, of about 60°. In contrast, the enhanced weld area transitions 814, 815 are oriented substantially normal to the strip length axis. Through mathematical modeling of the strip under varying conditions of stress and strain, it has been discovered that the beginning of the transitions 814, 815 should be offset from the weld centerline a distance equal to the width of the weld, plus the length of any weld (i.e., heat) affected microstructure, such as, but not limited to coarsened or refined size. For example, it has been found that offsetting the beginning of the transition section a distance of about 600% of the enhanced area wall thickness, tₑ, away from the weld 810 centerline is suitable to achieve the benefits of the present invention. This weld/transition relationship is illustrated as dimension “x” in FIGS. 8A and 8B.

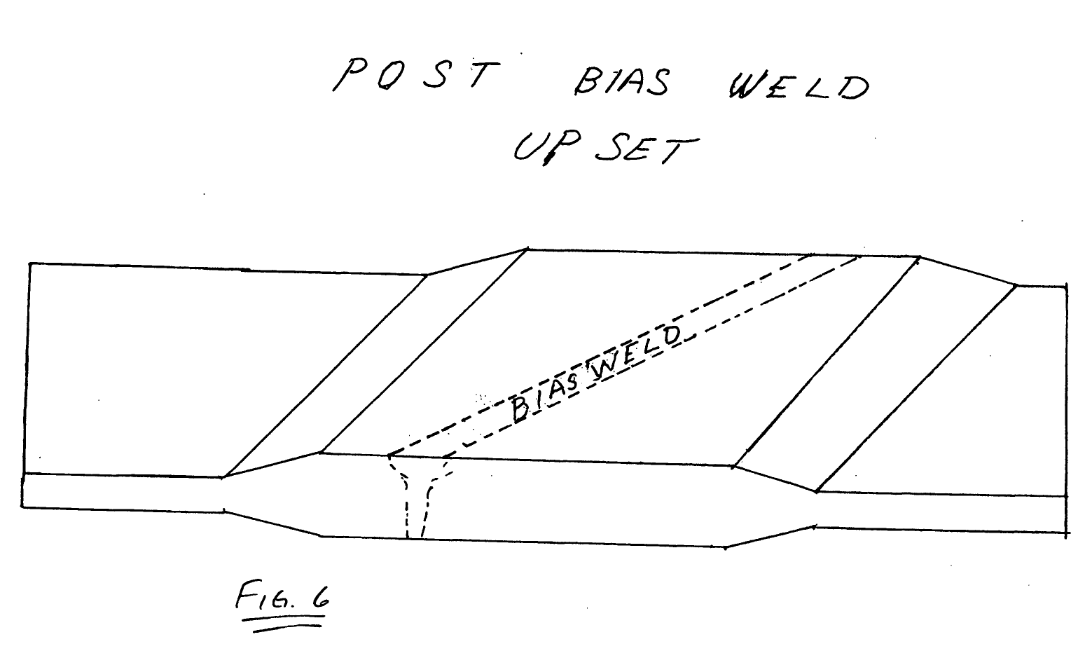

FIGS. 9A and 9B illustrate a strip-to-strip weld area that is similar to that illustrated in FIGS. 8A and 8B. The enhanced weld areas 913, 914 each have a shallow angle transition portion 914 and 915, such as the preferred 3.5° transition discussed above. However, the structure illustrated in FIGS. 9A and 9B is different from the structure illustrated in FIGS. 8A and 8B, in that the transition areas 914 and 915 are oriented parallel to the weld 910. For example, and not limitation, if the weld 910 is oriented or biased at about 45° to the strip length axis, then the transition areas 914, 915 also will be oriented at about 45° to the strip length axis. It can be seen by comparing FIGS. 8 and 9 that orienting the transition areas parallel to the weld reduces the length of the enhanced weld area. FIG. 9C illustrates a section of finished tube comprising the enhanced bias weld illustrated in FIGS. 9A and 9B. The asymmetrical portion of the enhanced weld area is shown, as an example and without limitation, on the inside surface of the coiled tubing. Although FIGS. 9A-9C show the weld 910 extending through the entire enhanced weld area thickness, it will be appreciated that the weld may extend only through the parent material thickness and be overlaid by a plate or deposited material, as discussed above.

FIGS. 8 and 9 illustrate transition areas having straight or linear entries into and exits from the transition area. It will be appreciated that the transition entries and exits do not have to be linear or straight and, alternately, can be shaped and or oriented to minimize the stresses and strains developed during use of the enhanced coiled tubing. FIGS. 10A through 10G illustrate several alternate transition shapes that may be used with the enhanced weld areas of the present invention. Although the transitions illustrated in FIGS. 10A-10G are shown in the “plate” configuration discussed above with respect to FIG. 4, it will be appreciated that these transitions are applicable to any implementation of any enhanced weld area disclosed or taught herein.

FIG. 10A illustrates transition areas 1014 and 1015 that comprise linear or straight entry portions, 1016, 1017, and sinusoidal exit portions 1018 and 1019. It will be appreciated that the entry portions are normal to the strip length axis and the sinusoidal exit portions are oriented about an axis normal to the strip length axis. The actual transition areas 1014 and 1015 may exhibit the shallow angle or radius discussed above or some other stress concentration reducing design. FIG. 10B is similar to FIG. 10A, except that the peaks of the sinusoidal exits 1018, 1019 are out of phase. FIG. 10C is similar to both FIGS. 10A and 10B, except that the sinusoidal exits 1018 and 1019 are oriented (i.e., biased) about an axis parallel to the weld axis (not shown), such as 45° or 60°. Also shown in FIG. 10C is a sinusoidal entry portion 1016 and 1017. FIG. 10D illustrates a linear, shallow angle exit portion 1018, 1019 and a linear relief groove entry portion 1016, 1017. FIG. 10E illustrates a bull nose exit portion 1018 and linear entry portion 1016, and, alternately, a bull nose exit portion 1019 and a bull nose entry portion 1017. FIGS. 10F and 10G illustrate exit portions comprising a trapezoidal shape and a parallelogram shape, respectively. As discussed above, it will be appreciated that the transition area 1014, 1015 can be the shallow angles discussed above, the radius discussed above or any other stress-concentration reducing shape. It will also be appreciated that the entry 1016 and exit portion 1018 may be identical or different, as discussed above.

Once the enhanced strip-to-strip welds, or multiple enhanced strip-to-strip welds, have been fabricated according to one or more aspects of the inventions disclosed herein, the continuous length of enhanced strip material may be fed through a tube-forming mill to create seam-welded coiled tubing, as disclosed in the patents incorporated herein. It is preferred that for asymmetrical enhanced weld areas, the asymmetrical wall thickness will form the inside surface of the coiled tubing.

It will also be appreciated that there may be many strip-to-strip welds in a continuous length of coiled tubing. Preferably, the welds will all be enhanced bias welds according to the inventions disclosed herein. Alternately, based on the expected use of the coiled tubing, the strip welds may be a combination of enhanced bias welds, enhanced butt welds, conventional bias welds and/or conventional butt welds. Still further, the increased wall thickness of the enhanced welds may vary according to the weld's location in the coiled tubing string. For example, and without limitation, in certain applications the strip welds adjacent the distal end of the coiled tubing string may be relatively minimally stressed and strained during use. Therefore, the distal portion of the string may be fabricated with conventional butt welds, enhanced butt welds, or conventional biased welds. As the state of stress and strain increases in portions of the string away from the distal end, the strip welds may be of the enhanced bias weld type having an increased thickness of about 107% of the nominal strip thickness. As the state of stress and strain increases further, the strip welds may be of the enhanced bias weld type having an increased thickness of about 110% or more of the nominal strip thickness.

As part of our invention, we mathematically modeled the complex states of stress and strain that we believe coiled tubing experiences during use. These states of stress and strain were modeled both for the enhanced weld area in the strip condition and in the tube condition. Through our research, we discovered that in the strip condition, the greatest reduction in stress and strain (therefore, the greatest increase in load bearing capacity) was created by the weld/transition orientation illustrated in FIGS. 8A-8B. In other words, in the strip condition, we discovered that orienting the transition area normal to the strip length axis predicted the greatest improvement in weld area performance. Unexpectedly, when we modeled the enhanced welds in the tubular condition, the greatest improvement in weld area performance was predicted by the orientation illustrated in FIGS. 9A-9C, in which the transition area is parallel to the bias weld axis.

FIG. 11 illustrates a continuous length of coiled tubing 1120 made according to one or more of the embodiments disclosed or taught herein spooled around a reel 1122. An enhanced weld area 1124 is shown just prior to being spooled onto the reel 1122. It will be appreciated that, having the benefit of this disclosure, the enhanced weld area 1124 likely will be stiffer than the immediately adjacent tubing section formed from nominal thickness strip material. Thus, the enhanced weld area may cause a kink or other discontinuity in the spooling or unspooling process. The length and area of the enhanced weld area likely will determine the spooling and unspooling characteristics of the coiled tubing. Because enhanced weld areas that have the transition area parallel to the weld axis are typically shorter than enhanced weld areas in which the transition area is normal to the strip length axis (compare FIGS. 8 and 9), it is believed that such shorter enhanced weld areas provide the greatest increase in coiled tubing performance. However, it is also believed that shorter enhanced weld areas increase the likelihood of a detrimental kink or bend during spooling or unspooling.

In yet another embodiment of our invention illustrated in FIG. 12, the weld area 1230 of conventionally formed coiled tubing 1232 (i.e., coiled tubing formed from continuous lengths of strip having a substantially consistent nominal thickness, t), can be enhanced after the strip has been formed into tubing. FIG. 12 shows the axial seam weld 1234 and the biased strip weld of the coiled tubing 1232. Also shown in cross section is sleeve 1238 having transitions 1240 and 1241, such as any of those discussed above. It is contemplated that sleeve 1238 will be bonded to the outside surface of coiled tubing 1232 by any of the processes discussed above concerning FIG. 3, 4 or 5, such as but not limited to amorphous diffusion bonding. It will be understood that the sleeve can be “closed” (i.e., a seamed or seamless cylinder) that is threaded into position before being bonded to the coiled tubing 1232, or the sleeve can be seam welded during the bonding process. Preferably, the sleeve seam weld will not overlay the axial seam weld 1234.

Similar to the embodiment shown in FIG. 12, FIG. 13 illustrates another embodiment in which the weld area 1330 of conventionally-formed coiled tubing 1332 (i.e., coiled tubing formed from continuous lengths of strip having a substantially consistent nominal thickness, t), is enhanced after the strip has been formed into tubing. FIG. 13 illustrates an enhanced weld area created through one or more of the material deposition techniques discussed above. Generic spray head 1340 is illustrated depositing material 1342 onto the coiled tubing 1332 to create the enhanced weld area of the present invention (shown in partial cross section). It will be appreciated that such material deposition techniques may not require subsequent transition area processing.

In addition to increasing the load-bearing area of the weld zone, our invention contemplates the use of metallurgical enhancements, such as cryogenic treatment, which is sometimes called cryogenic tempering. This process uses ultra-cold temperatures, down to about −300° F., to modify the micro-structure of the weld zone material and/or strip material. It is preferred that the increased thickness weld zone described above be subjected to cryogenic treatment to further improve the physical properties and rated life of the weld zone.

Other and further embodiments utilizing one or more aspects of the inventions described above can be devised without departing from the spirit of our inventions. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of our invention, but rather, in conformity with the patent laws, we intend to fully protect all such modifications and improvements that come within the scope or range of equivalents of the following claims.

What is claimed is:

1. A method of manufacturing a length of coiled tubing comprising:
providing a first length of strip material having a nominal thickness and a first end;
providing a second length of strip material having a nominal thickness substantially the same as the nominal thickness of the first length of strip material, and having a second end;
providing an area of increased material thickness extending longitudinally away from each strip end for a predetermined distance;
forming a weld along the first and second ends, thereby joining the first and second strips together to create a new length of strip material; and
forming the new length of strip material into tubing.

2. The method of claim 1, further including the step of creating a weldable edge through the increased thickness of the first and second ends and at an angle between about 15 and about 75 degrees relative to a longitudinal axis of the strips.

3. The method of claim 1, wherein the areas of increased thickness extend longitudinally beyond the weld for a distance of at least twice the increased material thickness.

4. The method of claim 1, wherein the areas of increased thickness blend into the nominal thickness of the strip material within a transition area on each strip.

5. The method of claim 4, wherein the transition areas are offset from the weld a distance of at least twice the increased material thickness.

6. The method of claim 4, wherein the transition areas are oriented parallel to the weld.

7. The method of claim 4, wherein the transition areas are oriented perpendicular across the strips.

8. The method of claim 4, wherein at least one of the transition areas traces a sinusoidal path across the associated strip.

9. The method of claim 4, wherein at least one of the transition areas trace a curved path across the associated strip.

10. The method of claim 1, wherein the areas of increased thickness transition to the nominal thickness of the strip material at an angle between about 2 degrees and about 7 degrees.

11. The method of claim 1, wherein the increased material thickness is at least 103 percent of the nominal thickness.

12. The method of claim 1, wherein the increased material thickness is between about 103 percent and about 125 percent of the nominal thickness.

13. The method of claim 1, wherein the step of providing with an area of increased material thickness comprises overlaying the strips with one or more plates.

14. The method of claim 1, wherein the step of providing with an area of increased material thickness comprises depositing material adjacent the first and second ends.

15. The method of claim 1, wherein the step of providing with an area of increased material thickness occurs after the step of forming the joined strip into tubing and comprises overlaying the weld with a sleeve or cylinder.

16. The method of claim 1, wherein the step of providing with an area of increased material thickness occurs after the step of forming the joined strip into tubing and comprises depositing material adjacent the weld.

17. The method of claim 1, wherein such that the weld is entirely within the areas of increased thickness

18. Coiled tubing formed from a plurality of lengths of flat strip material welded together, comprising:
the tubing having a nominal wall thickness along its length;
an enhanced strip weld area having a wall thickness that is at least 103 percent of the nominal tubing wall thickness and a longitudinal length away from the weld of at least twice the enhanced wall thickness; and
first and second transitions between the enhanced weld area and the unenhanced coiled tubing.

19. The coiled tubing of claim 18, wherein the flat strip weld is biased with respect to a longitudinal strip axis at an angle in the range of 45 degrees to 75 degrees.

20. The coiled tubing of claim 19, wherein the first and second transitions comprise a shallow angle of about 3.5 degrees.
